(19) United States
(12) Patent Application Publication
(10) Pub. No.: US 2011/0115185 A1
(43) Pub. Date: May 19, 2011

(54) Integrated driven half-shaft and wheel hub module

(76) Inventor: Frank Victor Csik, Beaconsfield (CA)

(21) Appl. No.: 12/929,254

(22) Filed: Jan. 11, 2011

Related U.S. Application Data
(63) Continuation-in-part of application No. 11/984,358, filed on Nov. 16, 2007.
(60) Provisional application No. 60/859,588, filed on Nov. 20, 2006.

(51) Int. Cl. B60B 35/14; B60B 35/12

(52) U.S. Cl. 280/124.125; 280/124.1

(57) ABSTRACT

In the interest of simplified assembly and servicing procedures for motorized land vehicles, there is provided an upright for mounting and supporting a pre-assembled sub-assembly comprising a hub outer casing member ensconcing a pair of bearings therein for rotatably supporting a co-rotating hub member consisting of inboard and outboard members for mounting a road wheel thereto, a driven half-shaft connected to said hub module at its outboard end and to a vehicle final drive output shaft at its inboard end with outboard and inboard universal joints respectively.

The present application is a continuation in part (CIP) of the currently pending application having Ser. No. 11/984,358 filed on Nov. 16, 2007; that in turn claimed the benefit of Provisional Patent having Application No. 60/859,588 filed on Nov. 20, 2006. It is to be noted that the pending application's “as submitted” title reading “COMPACT WHEEL HUB UNIT FEATURING AN INTEGRATED CONSTANT VELOCITY JOINT OUTER RACE” is herewith requested to be changed to read “INTEGRATED DRIVEN HALF-SHAFT AND WHEEL HUB MODULE” in order to more accurately describe the invention.

### FIELD OF THE INVENTION

The present invention describes improvements to the assembly procedure of wheel hub with driven half-shaft for vehicles of all layouts; it is suitable for vehicles of all drive configurations, including Front-Wheel-Drive (FWD) and All-Wheel Drive (AWD) and Rear-Wheel-Drive (RWD) systems, and more specifically it describes an upright with and open jaw for receiving a pre-assembled hub/half-shaft module in a single action.

### BACKGROUND TO THE INVENTION

To date, there has not been any real attempt made by motor vehicle manufacturers to simplify the installation of driven half-shafts either at the initial manufacturing stage or later during routine maintenance. This invention focuses on easing the installation and servicing of the driveshaft located between the differential and the wheel.

The suspension components may be left attached to the vehicle completely if the drive axles need servicing; they do not need to be partially disassembled whenever either CV joint is in need of servicing.

In this invention the entire half-shaft drive axle sub-assembly, comprising the driveshaft, the inboard and outboard universal joints, and the wheel hub with inboard and outboard wheel bearings, can be installed into the vehicle in a single action.

The upright has a generally crescent shaped mid-section, which enables nesting the half-shaft's bearing housing outer casing into it when assembling the driveshaft into the vehicle. Viewed from the side, the crescent is open to the front, so that the vehicle is inherently better supported under braking, when the loads maybe the highest, although arranging it the other way around is also workable, especially when employed in rear wheel drive applications. The hub carrier is part of the driven half-shaft subassembly, and is secured to the upright by screws penetrating the carrier laterally from the outside, and with additional screws mounted from the front. The screws mounted from the front develop a clamping force on the upright tightening it on to the carrier, so that the entire assembly forms a solid structure maximizing its bending strength.

### SUMMARY OF THE INVENTION

The objective of the present invention is to provide a simple to install and/or service a driven half-shaft and wheel hub module in a land vehicle, and that objective is achieved with a preassembled interconnecting arrangement comprising a driven wheel's hub composed of form-fittingly joined co-rotating inboard and outboard members, complete with bearing seals, form fitting keys for enabling said inboard and outboard members to be locked into a co-rotating engagement, a deformable ferrule for locking said inboard and outboard members into an inseparable unit, complete with seal screw and dust cap with O-ring, a generally cylindrical outer casing member, a pair of inboard and outboard wheel bearings occupying the annular space between said hub and said outer casing members, wherein each of said inboard and said outboard bearing rows is comprised of a plurality of rolling elements being suitable for supporting combined axial and radial loads and further, wherein said hub subassembly's said inboard member is a CV joint outer race proper, and whereof said form fitting means of interconnecting mechanism enables the bearings to be in a preloaded union with their respective inner and outer raceways, and said hub is attached to a driven half-shaft complete with and inboard universal joint, and inboard and outboard CV joint boots, the complete module ready to be installed in place with suitable fasteners by form-fittingly attaching the inboard CV joint to the vehicle's final drive output member at the inboard side, and attaching said hub carrier to said upright at the outboard side.

According to one aspect of the invention, there is provided an interconnecting arrangement an integrated driven half-shaft and wheel hub module comprising a conventional driven half-shaft complete with an inboard universal joint, inboard and outboard dust boots and a form fitting round section retaining ring for locking said shaft into said hub's said inboard member defining said outboard universal joint's outer race, and a wheel hub comprising a generally cylindrical outer casing member with mounting flanges, an interconnected co-axial and co-rotating hub sub-assembly comprised of an outboard and an inboard member with respective inner raceways thereon, wherein said inboard member is defined by a CV joint outer race member having a shoulder adjacent to and outboard of said raceway thereon for confronting a corresponding planar surface of said outboard member, a form-fitting coaxial generally cylindrical stub axle with a concentric bore and a concentric threaded counter-bore at its outboard end, said stub-axle extending outwardly from said hub's said inboard member, and a matching cage and inner race with a set of bearing balls for said inboard member completing said outboard universal joint, and a flanged outboard hub member having a generally cylindrical main body with a concentric generally cylindrical through-bore originating on the inboard planar surface thereof, inboard and outboard wheel bearings each having a plurality of rolling elements and inboard and outboard bearing seals, wherein said interconnected driven half-shaft and wheel hub module sub-assembly, said inboard and outboard wheel bearings and said seals are arranged on mutually coaxial axes, and wherein said hub sub-assembly is being rotatably supported within said outer casing member by said wheel bearings and said hub flange is having provisions for mounting a road wheel thereto, the arrangement comprising a mechanism for rotatably mounting a road wheel into a suspension upright, while said driven half-shaft extending inboard of said hub is configured with a form-fitting mounting provision to be attached to the vehicle's front and/or rear final drive output flange.

In this arrangement the hub's inboard and outboard members are non-rotatably engaged to each other with a plurality of radially disposed keyways and matching keys simultaneously embedded in both of said hub's said inboard and outboard members, and said inboard and outboard members are inseparably secured to each other with a locking ferrule concentrically mounted on to the protruding outboard end of said hub's said inboard member Said inboard member's said integral outwardly extending coaxial cylindrical stub axle is provided with a first set of radially disposed axially oriented suitably shaped plurality of keyways thereon and a generally cylindrical through-bore therein, and further, at its outboard end said stub axle is provided with a concentric conical undercut for interlocking with a deformable locking ferrule, and said outboard member's said bore is provided with a second set of radially disposed axially oriented suitable shaped plurality of keyways matching said first set of keyways in said inboard member. At the time of mating said inboard member's said stub axle into said outer member's said bore said matching keyways in said inboard and outboard members are carefully aligned so as to permit insertion of said form fitting keys into said keyways, and said members are pressed together until said stub axle's said shoulder confronts said outer member's said inboard planar surface, causing a portion of said stub axle to protrude through said outboard member's outboard end. The joining operation is completed by inserting said ferrule on to said stub axle's said protruding portion, and forcibly deforming said ferrule to tightly engage said stub axle's said undercut, thus trapping said outboard member and said keys, and creating an inseparable assembly therewith.

Next, the wheel hub and the half-shaft are fitted to each other in a conventional manner, whereby the build-up of the outboard CV joint precedes attachment of said half-shaft to said outboard CV joint. Completion of said outboard CV joint commences by putting said inner race inside said cage of said hub's said inboard member by lining up the narrow point of said inner race to the broad section of said hub's said inboard member, inserting said bearing balls into said cage's openings, followed by placing said inner cage with said race and said bearing balls into said hub's said inboard member defined by said CV joint outer member, and lining up the narrow point on said inner race to the broad point of said outer race. Once said outboard CV joint is assembled, said CV joint is ready to be packed with suitable grease, then said half-shaft outboard end is ready to be installed into said outboard CV joint's said inner race. This step commences by stretching the small end of said boot around said outboard end of said shaft, and then sliding said boot down into position, so that said boot's said small end sits between the two bumps inboard of splined end on said shaft. Further, said dust boot's large end is pushed further back by doubling it over said small end on said boot over said shaft. In the next step, said retaining ring is placed on to said half-shaft's corresponding groove near the outboard end of said half-shaft, and by fitting said half-shaft's outboard end into said CV joint's said inner race until it meets resistance, at which point a suitable threaded draw bolt tool is inserted through the outboard end of said hub's said outboard member and is threaded into said half-shaft's said threaded bore. This is followed by tightening said threaded tool to draw said half-shaft into said CV joint's said inner race, compressing said retaining ring all the while, until said retaining ring reaches a clearance groove inside said CV joint's said inner race, where said retaining ring once again relaxes and springs open, locking said half-shaft and said CV joint inner race together. Next, said boot's said large end is folded forward and stretched over the outer surface of said hub's said inboard member defining said outboard CV joint's said outer race, followed by placing clamping collars over both ends of said boot.

The remaining steps in completion of the entire half-shaft drive axle sub-assembly entails removal of said draw bolt tool, and threading said seal bolt and pressing said dust cap with said O-ring into the open outboard ends of said hub's said inboard and outboard members respectively.

At this point, said module is ready to be installed into a vehicle.

### BRIEF DESCRIPTION OF THE DRAWINGS

Having thus generally described the invention, reference will be made to the accompanying drawings illustrating embodiments thereof, in which:

FIG. 8 is an isometric view of one embodiment of a completed installation of an upright and hub/half-shaft module in a vehicle for a driven wheel drive mechanism;

FIG. 9 is isometric view of a hub/half-shaft module being drifted into position for installation to the upright.

FIG. 10 is an isometric rear view of one embodiment of an integrated driven half-shaft and wheel hub module for a driven wheel drive mechanism;

FIG. 11 is an isometric exploded rear view of one embodiment of an integrated driven half-shaft and wheel hub module for a driven wheel drive mechanism illustrating the half-shaft module not yet attached to the hub module;

FIG. 12 is a sectional view of one embodiment of an interconnecting arrangement for a driven wheel hub module and hub drive mechanism;

FIG. 13 is a partial cutaway isometric view of one embodiment of an interconnecting arrangement for a driven wheel hub module as the locking ferrule is being placed into position before clinching same to engage the stub axle's undercut rim;

FIG. 14 is an isometric view of a ferrule in its relaxed form;

FIG. 15 is a partial cutaway isometric view of one embodiment of an interconnecting arrangement for a driven wheel hub module after the locking ferrule has been clinched to engage and lock into position the stub axle's undercut;

FIG. 16 is an isometric view of a ferrule in its clinched form;

FIG. 17 is an isometric view of an upright;

### DESCRIPTION OF THE PREFERRED EMBODIMENTS

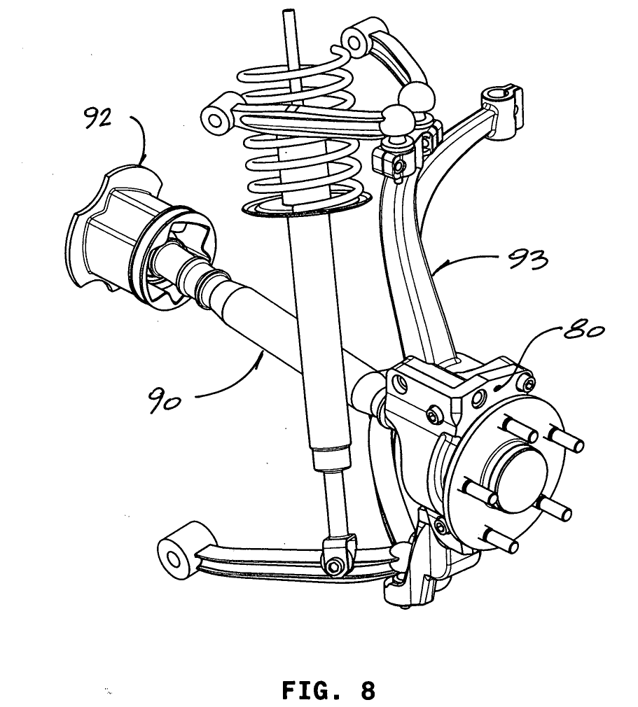

Referring to the drawings in greater detail and by reference characters thereto, in FIG. 8 there is illustrated in isometric view a completed installation in a vehicle, showing upright 93 and hub/driven half-shaft module comprising inboard universal joint 92, half-shaft 90 and hub casing 80.

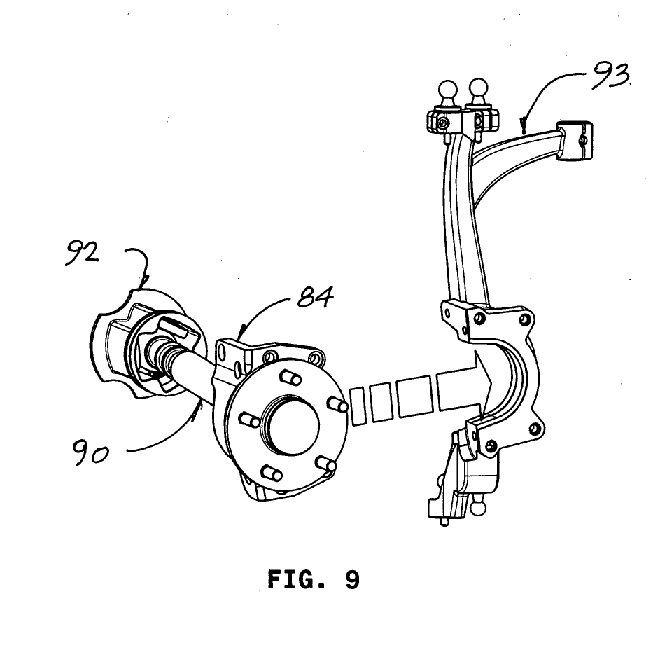

Referring to the drawing in FIG. 9, there is illustrated in isometric view a driven hub/half-shaft module 80, 90 and 92 being drifted into position for installation to the upright 93.

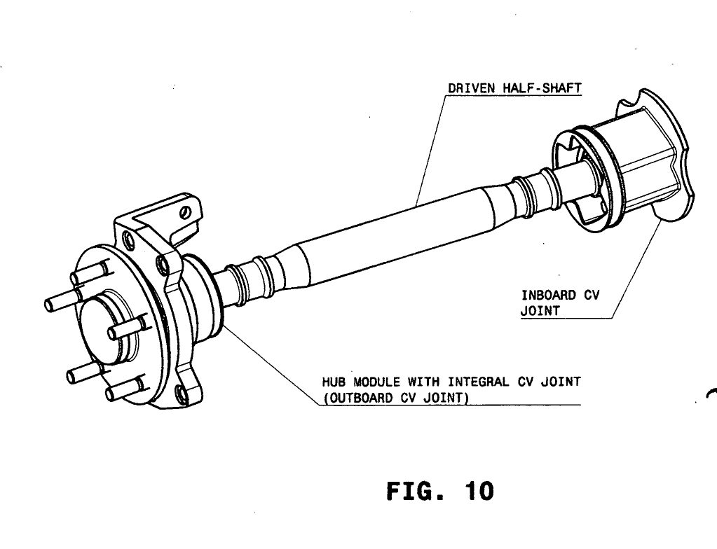

Referring to the drawing in FIG. 10 there is illustrated an isometric view of the integrated driven hub/half-shaft module noting the terminology referring to elements thereof and occurring throughout this document.

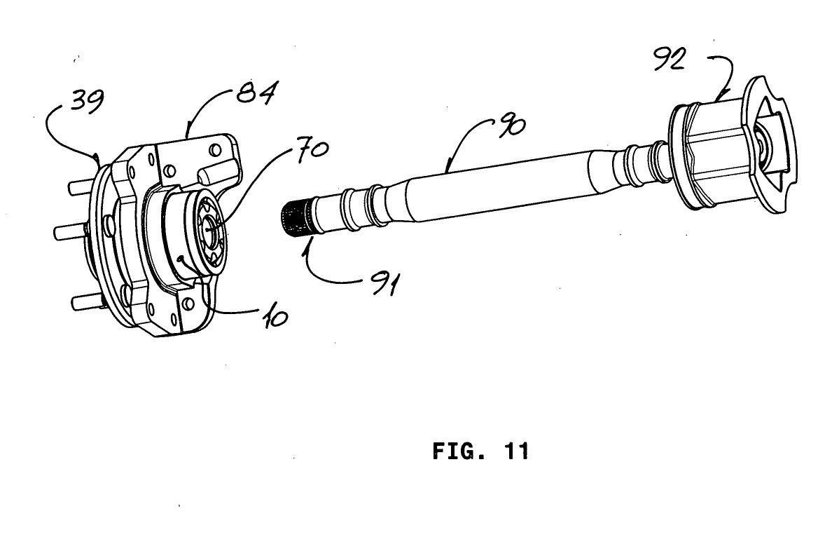

Referring to the drawing in FIG. 11, there is illustrated a partially exploded isometric view of the hub module ensconcing inboard member 12 and outboard member 39 in hub casing 80 with inboard member ensconcing outboard CV joint inner race 70, and the integrated driven half-shaft 90 with retaining ring 91 and inboard CV joint 92.

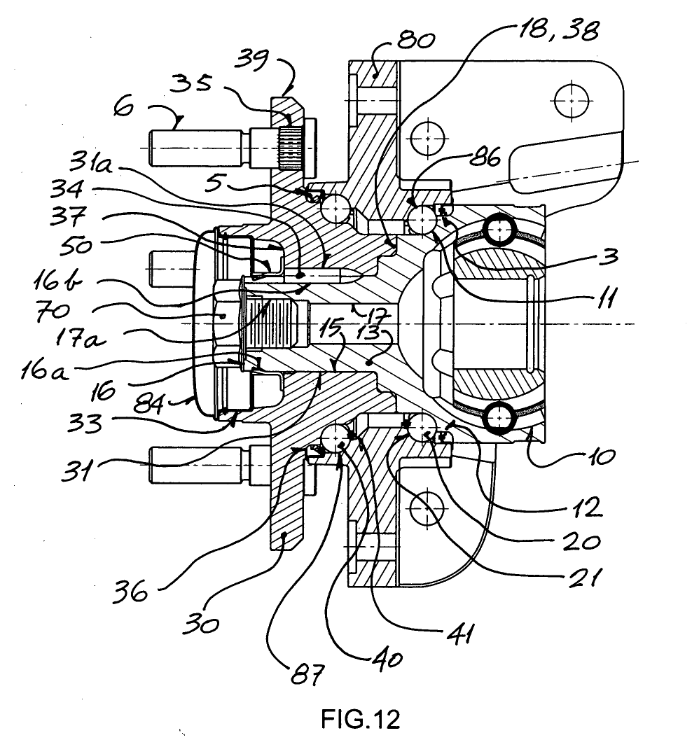

Referring to the drawing in FIG. 12, there is illustrated in sectional view a wheel hub and axle drive mechanism whose inboard and outboard bearing rolling elements 20 and 40 respectively are spherical, a rotatable wheel hub sub-assembly comprised of an inner member defined by a CV joint outer race 10 and outboard member 30, a plurality of inboard rolling elements 20 retained thereto by spacer cage 21, a plurality of outboard rolling elements 40 retained thereto by spacer cage 41, an inboard bearing seal 3, an outboard bearing seal 5, and finally wheel mounting threaded lugs 6 and a hub module outer casing member generally designated by reference numeral 80, said outer casing member having at least two suitable means for securely attaching to a vehicle suspension upright.

The induction hardenable or case-hardenable steel CV joint outer race 10 is configured to include an annular raceway 11 for being in bearing contact with rolling elements 20 being retained thereto by spacer cage 21, a machined journal 12 for bearing seal 3, an integral coaxial outwardly extending stub axle 13 defined by journal surface 15 having a concentric conical undercut 16a with outboard ridge 16 and a plurality of a first set of radially disposed axially oriented suitable form fitting keyways 16b thereon, whereof by virtue of an undercut resulting in a conical undercut neck 16a, there is provided an outwardly extending concentric annular nosing 16 confronting seal bolt 70 and a cylindrical bore 17 and threaded counterbore 17a therein.

Hub module outboard member 30 includes a concentric annular bore 31 to come into contact with and radially support said journal surface 15 of said stub axle 13, and a coaxial outboard counterbore 33 to come into contact with dust cap 84, and a face 37 therein, a face 38 abutting shoulder 18 of said CV joint 10, and a second raised coaxial journal seat 36 for coming into contact with outboard bearing seal 5, a plurality of radially disposed and axially oriented keyways 31a and matching keys 34 simultaneously embedded in both of said hub's said inboard member 10 and outboard member 30, and finally a hub flange 39 is provided with bolt holes 35 thereon for securing the threaded wheel mounting lugs 6 therein. Said hub 30 is held securely in position on said inboard member 10 coaxial outwardly extending stub axle 13 by said coaxial ferrule 50 deformed into permanent union with said concentric outboard undercut 16a of said inboard member 10, locking said inboard member 10 and outboard member 30 into an inseparable unit.

The hub module assembly comprises an inboard hub member defined by a CV joint outer race 10, a hub outboard member 30, a hub module outer casing member 80, a plurality of inboard rolling elements 20 with spacer cage 21, a plurality of outboard rolling elements 40 with spacer cage 41, wherein said rolling elements 20 and 40 are in rolling contact with integral inboard 86 and outboard 87 raceways respectively of said outboard casing member 80 and said hub sub-assembly comprised of said outboard member 30 and said inboard member 10 respectively, and wherein said hub module further includes inboard and outboard wheel bearing seals 3 and 5 respectively.

At the time of inseparably joining said CV joint outer race proper 10 to said hub outboard member 30, said stub axle's said cylindrical journal surface 15 is axially inserted into the said snug fitting annular bore 31 of said hub 30 and said two parts are pressed together until their respective mating surfaces confront each other, resulting in a predetermined load developed on said inboard and outboard bearing's rolling elements. The uniting force is maintained until shoulder 18 of said CV joint outer race proper 10 abuts said face 38 of said hub 30, at which time said rolling elements and said inner and outer raceways are drawn to one another with a predetermined level of load. The joining operation is completed by concentrically inwardly deforming the unsupported outboard portion of said ferrule 50 causing the outboard end of said ferrule to confront said outboard ridge 16 therein, creating an inseparable assembly thereof.

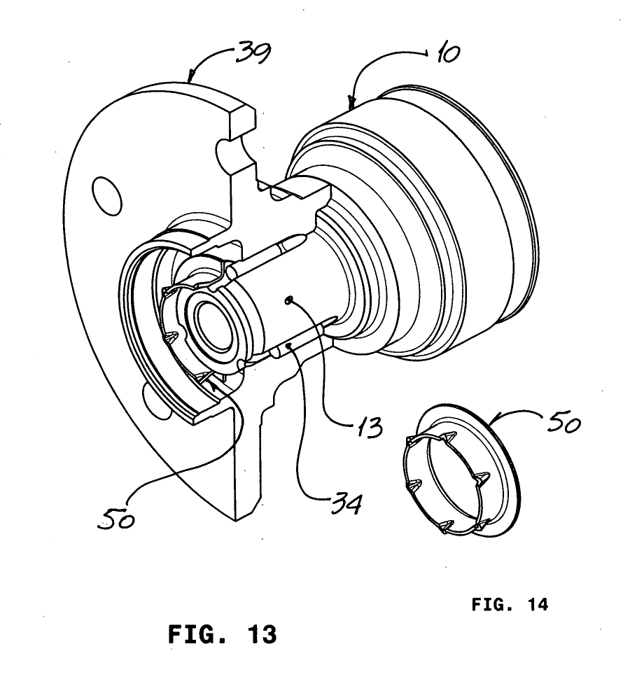

Referring to the drawing in FIG. 13, there is illustrated in isometric view an outboard member 39, inboard member 10 having stub axle 13, keys 34 and a ferrule 50 in its relaxed state being inserted into its final position on to said stub axle 13.

Referring to the drawing in FIG. 14, there is illustrated in isometric view a ferrule 50 in its relaxed state in isolation for clarity.

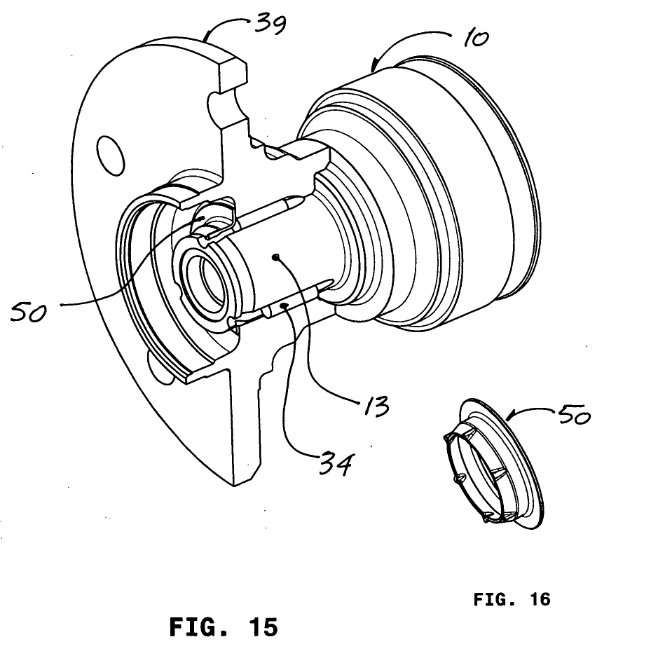

Referring to the drawing in FIG. 15, there is illustrated in isometric view an outboard member 39, inboard member 10 having stub axle 13, keys 34 and a ferrule 50 in its clinched state in its final position on said stub axle 13.

Referring to the drawing in FIG. 16, there is illustrated in isometric view a ferrule 50 in its clinched state in isolation for clarity;

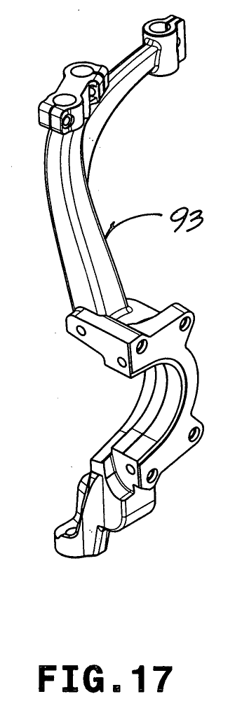

Referring to the drawing in FIG. 17, there is illustrated in isometric view an upright 93 in isolation for clarity;

It will be understood that the above-described embodiments are for purpose of illustration only and that changes and modifications may be made thereto without departing from the spirit and scope of the invention.

I claim:

1-10. (canceled)

11. A pre-assembled integrated wheel hub and driven half-shaft module made up of a self-contained hub comprising a co-axially arranged co-rotating sub-assembly consisting of inboard member and outboard member having a radially disposed peripheral flange for mounting a road wheel thereto, an outer casing member ensconcing a pair of bearings therein rotatably supporting said co-rotating sub-assembly for mounting said module to a suspension upright, a driven half-shaft connected to said hub module at its outboard end and to a vehicle final drive output shaft at its inboard end with outboard and inboard universal joints respectively.

12. A co-rotating wheel hub comprised of an outboard member having a concentric annular bore therein radially supporting the outwardly projecting fully inserted axially oriented concentric stub axle of a fully seated mating inboard member having a protruding concentric conical undercut and annular ridge portion thereon, wherein said stub axle and said concentric bore are engaged in a co-rotating arrangement by a plurality of radially disposed axially oriented form-fitting matching keyways and keys simultaneously embedded in both of said hub's said inboard and outboard members, and are held in a preloaded inseparable union with one another by a concentric ferrule member fully deformed on to said protruding conical undercut, and locked in place by said annular ridge.

13. A suspension upright having a generally crescent shaped open jaw mid-section facing either forward or towards the rear of the vehicle, with suitable fasteners enabling form fittingly nesting a hub carrier casing of a driven half-shaft module therein when assembling said half-shaft with said hub into the vehicle.
